(19) United States
(12) Patent Application Publication
(10) Pub. No.: US 2008/0091499 A1
(43) Pub. Date: Apr. 17, 2008

(54) SYSTEM AND METHOD TO CONTROL CACHING FOR OFFLINE SCHEDULING

(75) Inventors: Cynthia E. Barber-Mingo, Westford, MA (US); Gary Denner, Celbridge (IE); Ruthie D. Lyle, Durham, NC (US); Patrick J. O'Sullivan, Dublin (IE)

Correspondence Address: CANTOR COLBURN LLP - IBM LOTUS, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/537,857

(22) Filed: Oct. 2, 2006

(51) Int. Cl. G06F 15/02

(52) U.S. Cl. 705/9

(57) ABSTRACT

Systems and methods to control caching for offline scheduling services. Exemplary embodiments include a computerized method for managing electronic calendar schedules, including selectively providing calendar information to a chairperson for caching the calendar information related to a group of users while connected to a network, defining a relationship with the chairperson, defining an information level depending on the relationship with the chairperson, periodically updating a log file that contains data related to the information level and responding to a proposed meeting schedule.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND

The present disclosure relates generally to calendar applications, and, in particular, to systems and methods to control caching for offline scheduling.

Electronic calendaring tools allow a meeting chairperson to schedule a meeting for multiple participants very easily. For example, a chairperson can arrange a meeting between multiple participants having access to the electronic calendaring tools. Although quite useful, the drawback to the calendaring solution is that in order for the chairperson and the participants to properly coordinate, the chairperson and the participants must be online to exchange schedule information for the persons being invited to the meeting. This schedule information can be visually relayed to the sender, where shaded time slots, for example, indicate a scheduled event. The visual indication typically signifies that a particular time slot is available, already scheduled or busy. The visual indication can also signify that the calendar is completely blocked, with no information pertaining to being available, already scheduled or busy. The visual indication can also signify that the calendar is completely open, that is, either all users or a subset thereof (for example a list of persons) can view all calendar information. Calendar information can also include specific information about meetings, etc.

### BRIEF SUMMARY

Embodiments of the invention include a computerized method for managing electronic calendar schedules, including selectively providing calendar information to a chairperson for caching the calendar information related to a group of users while connected to a network, defining a relationship with the chairperson, defining an information level depending on the relationship with the chairperson, periodically updating a log file that contains data related to the information level and responding to a proposed meeting schedule.

Additional embodiments include a method for managing electronic calendar schedules in a computer system having a graphical user interface including a display and a selection device, the method including determining a relationship and an information level with respect to a chairperson, selectively deciding to allow access to calendar information so that the chairperson can cache the calendar information for online and offline meeting scheduling, updating a log file having data related to the information level, selectively displaying a proposed meeting on the display, the meeting being scheduled based on schedules from cached calendar information of users who gave access to the chairperson and informing the chairperson of any conflicts regarding the proposed meeting.

Further embodiments include a computer readable medium having computer-executable instructions for performing a method, including managing an electronic calendar coupled to a network, defining a relationship with a chairperson, defining an information level to which the chairperson is permitted to access for caching for purposes of scheduling a proposed meeting, responding to an invitation to a proposed meeting, informing the chairperson of any conflicts with respect to the proposed meeting, updating a log file regarding the level of information and providing access to calendar information in response to a request for access to the calendar information.

Other systems, methods, and/or computer program products according to embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is block diagram is a block diagram illustrating a system in which caching calendar schedules for offline scheduling services may be implemented in accordance with exemplary embodiments;

FIG. 2 is a flow diagram describing processes for implementing caching calendar schedules for offline scheduling services in exemplary embodiments; and

FIG. 3 depicts simplified block diagram of a user interface with sample data relating to a calendar program including caching calendar schedules for offline scheduling capabilities, the user interface utilized in implementing the caching calendar schedules for offline scheduling services in exemplary embodiments.

The detailed description explains the preferred embodiments of the invention, together with advantages and features, by way of example with reference to the drawings.

### DETAILED DESCRIPTION

Exemplary embodiments include a system and method that allows a potential meeting participant to specify the level of detail/granularity of the information that can be cached concerning his or her calendar, by a requesting meeting chairperson, based on the relationship between the participant and the meeting chairperson from the participant's perspective. In this regard, the person who's information is being cached can control what is being cached and by whom. In general, a meeting scheduler is able to cache schedule information for selected meeting participants defined by intelligent adaptive sensing that enables the scheduler to successfully schedule a meeting while disconnected from the network (offline), based on detail/granularity set by each potential meeting participant. The system and methods allow a meeting scheduler to have enough information about a selected list of participants (defined by intelligent adaptive sensing) such that she could successfully schedule a meeting while offline and disconnected from her peers on the network. If there is a conflict due to an unexpected change in a participant's schedule, the cache for the participant with the conflict would be refreshed and the information used to reschedule the meeting. Organizational distance schemes to automatically select/remove potential meeting participants, for which schedule information can be cached, can also be implemented.

Exemplary embodiments of the systems and methods allow a potential meeting participant to determine what (the detail level of information permitted to be cached) by whom (a particular meeting chairperson(s) attempting to cache this information) based on the relationship between the potential meeting participant and the meeting chairperson from the participant's perspective. The system and methods allow a definition of an access control list (ACL), that is, a roster of users and groups of users, along with their rights, based on relationship (from the participant's perspective), which would control the detail level of information being viewed by an interested party. For example, User A is able only to have a visual indication that User B is busy, while User C may be able to able to obtain a detail account of User B's calendar, as in the open case. The systems and methods can apply for both the case of caching information and for general viewing of a person's calendar. Therefore a participant can control the level of information taken from their calendar. For example it might be enough for the chairperson to see that the participant is already booked. But it might not necessary for the chairperson to see the details of the meeting. In other cases when a meeting depends on another meeting, for example, the chairperson might need more detailed information. Thus, she would want to see more details. Therefore, given that offline caching is possible, the methods and systems described herein determine what level and how detailed can the chairperson cache the information.

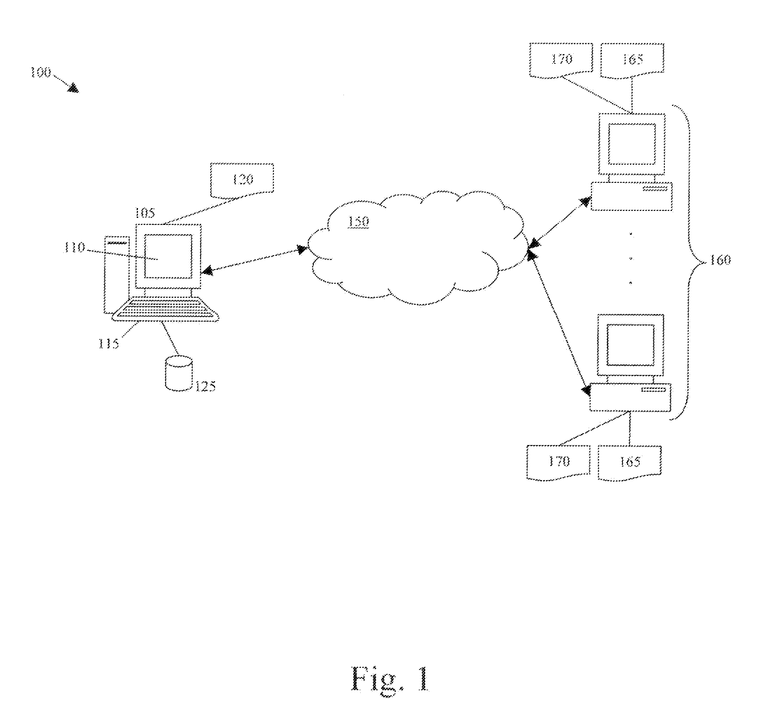

FIG. 1 is block diagram is a block diagram illustrating a system 100 in which caching calendar schedules for offline scheduling services may be implemented in accordance with exemplary embodiments. System 100 generally includes a chairperson computer 105, having a display 110 and input/section device 115, which can be a keyboard, mouse, combinations thereof, etc. Chairperson computer 105 is connectable to network 150. A series of user computers 160, each having a calendar application 165, are coupled to network 150. User computers 160 can further be coupled to a log file 170. The meeting participant can have access to log file 170, which stores the information including to whom the participant has given access, and how much access the participant has given. After a user-specified time period (i.e., week) log file 170 is sent to the potential participant to remind them of the access they have given and the details so they can choose to revoke access or update current access rights (i.e., allow some more detail or less detail).

In general, as discussed further in the description below, chairperson computer includes application 120 for caching calendar schedules for offline scheduling services. As such, chairperson computer 105 is capable of scheduling events such as meetings while offline by retaining a cached information in a storage medium 125 that is actively and adaptively collected while chairperson computer is connected to network 150. As discussed further in the description below, users implementing calendar applications 165 are able to control the level of detail for calendar information made available to chairpersons for caching based on the relationship between the participant and chairperson, from the participant's perspective.

As discussed, chairperson computer 105 includes functionality that allows a chairperson to cache schedule information in storage medium 125 for potential meeting participants while she is online. The granularity/detail of the cached information could be based on the relationship between the chairperson and each of the participants, having user computers 160, based on the participant's point of view. As appropriate information could be cached for varying periods of time, for example, for a week, a month or a year or other suitable periods. Other subsets of time periods could also be implemented, for example only Monday to Wednesday of each week for 2 months. A cache refresh rate could then be defined with respect to, but not limited to: the relationship between the chairperson and participant, defined by the chairperson for specific participant(s), or could be triggered by a calendar actions (for example a change in the participant's calendar).

The chairperson, while disconnected from the network 150, would then use the cached participant information from storage medium 125 to schedule a “proposed” meeting. When the chairperson connects to the network 150 again, the meeting would be added to the participants' calendar applications 165. If there is a conflict (due to an unexpected change in a participant's schedule) the cache for the participant with the conflict would be refreshed and the information used to reschedule the meeting. The chairperson would be prompted to select another time slot manually or intelligence could be added to the application to automate the reschedule of the meeting. In general, the cache is a file or other repository of schedule/availability information that would be updated frequently and discarded when no longer relevant. In addition, the cache can periodically be dumped. In dumping the cache, the cache data is discarded automatically when the cache is refreshed. In addition a “keep-alive” feature could be defined that allows the cache to be dumped before the next expected refresh.

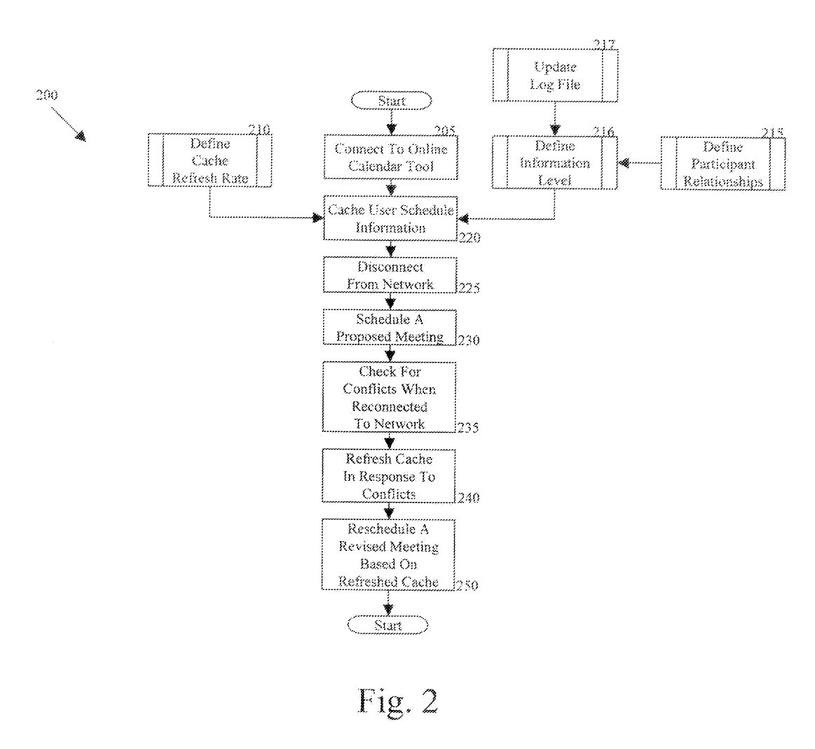

FIG. 2 is a flow diagram describing a process 200 for implementing caching calendar schedules for offline scheduling services in exemplary embodiments. In general, at step 205, chairperson connects to network 150 and to online calendar tool, application 120. As discussed above, a cache rate can be defined at step 210. In addition, participants' relationships can be defined at step 215. In addition to a determination of relationships at step 215, which can be driven by the chairperson, information detail and granularity can be defined at step 216, which is driven by the participant. There are many examples of relationship definitions that can exist between the chairperson and participant(s) (which can be logically combined), with an associated information level, including but not limited to: no special relationship basic/default information level; participants on the chairperson's instant message (IM) buddy list (which can be defined to a group level)—IM relationship-determined information level; special relationship in the enterprise hierarchy—enterprise-determined information level; participant is active in the chairperson' mail queue—email-determined information level; participant has frequent presence on the user's calendar—frequency in calendar-determined information level; and participant has been defined by the user to be “selected” to receive custom information—user-selected-determined information level, etc. An information level is the detail/granularity that has been allowed by the participant. There may be situations where there is “no relationship”. In such cases, a check box can be included on the user interface for calendar applications 120, 165. Such a checkbox can allow the chairperson to send a request to the participant for calendar information from the participant to begin caching.

There may be occasions when the user wishes to override the cache rate based on a relationship. These occasions have practical application when there may be an interaction that can supercede the relationship. For example, a person is working on a project that has a deadline in two weeks, but the refresh rate associated with the relationship is not frequent enough.

At step 217, the log file can be updated as discussed above. At step 220, user (calendar and schedule) information is cached, generally to storage medium 125. At sometime, the chairperson may disconnect from the network at step 225. At that time, the chairperson may schedule a proposed meeting, while offline, at step 230. The chairperson could then reconnect to the network 150. At that time, at step 235, the chairperson can check for schedule conflicts related to the proposed meeting. When conflicts have been resolved, it is appreciated that the cache can be refreshed 240 to represent new patterns of scheduling that may exist between the chairperson and the other participants. As such, when the cache is refreshed, the chairperson has a new cache of information that can be utilized in future schedules while offline. Any changes to the detail/granularity made by individual participants can also be properly cached at this step. In this way, the cached information is adaptive, allowing for better and better accuracy in scheduling meetings while offline. At step 250, a new meeting can be proposed based on the refreshed cache.

In general, although process 200 defines a series of steps in order, it is understood that the steps may occur at different times and that the connection and disconnection to network 150 may occur at different times.

It is therefore appreciated that intelligent sensing of the user's environment is a catalyst to keeping the user's cache relevant. For example, if a user adds a person to their buddy list (in a folder that they deem important) then the user's cache can be updated automatically (or via user preference/prompting) with this new user. Likewise, when a user is inserted in to the employee's team (e.g. new employee, new manager) the calendar information is also cached for this purpose. In an exemplary embodiment, organizational distance is applied to an abstraction that is based on the scheduler's lightweight directory access protocol (LDAP) tree (organizational distance can therefore be user configurable), thereby furnishing a list of individuals that are automatically cached for the scheduler. In another exemplary embodiment, reciprocal is also true. Therefore, when a person leaves the tree, the user is automatically promoted with a view to removing them. Information/patterns in the scheduler's mailbox can contribute to prompted requests to add a new user to the cache, for example—if a pattern emerges that a user is frequently emailing or in calendar events with User A, then this pattern can force an auto-prompt such that calendar information for Person A is added to the user's cache. Other patterns that define implicit relationships can also be defined. For example, if a pattern is formed where User A experiences a number of IM conversations with User B (threshold is user defined) then automatic prompting to cache this user would take place.

Therefore, a user interface that manages the users cache, for example, to delete users (in a persistent or non persistent way), add users, (in a persistent or non persistent way), to arbitrarily define the time-span/range on a per-user basis (e.g., a user wants User A's calendar data for 3 months in to the future, User B's calendar for a year in to the future, User C's for a week), etc. A user interface can further be implemented to manage relevant patterns and relationships.

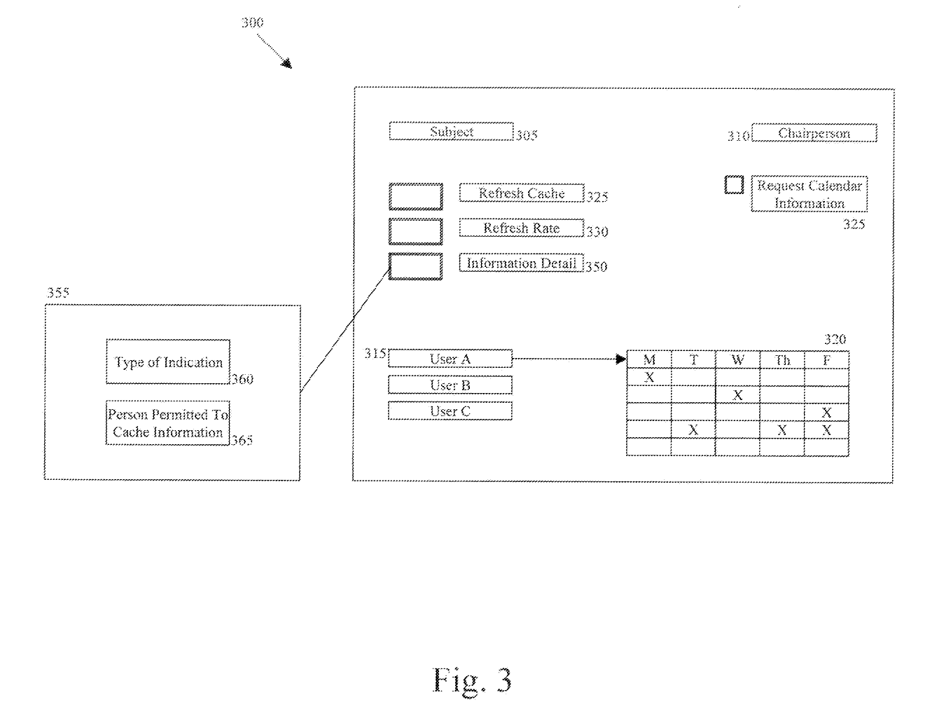

FIG. 3 depicts simplified block diagram of a user interface 300 with sample data relating to a calendar program including caching calendar schedules for offline scheduling capabilities, the user interface utilized in implementing the caching calendar schedules for offline scheduling services in exemplary embodiments. The methods described above can be implemented via user interface 300. User interface 300 can include a subject line 305 and chairperson field 310, which would define where cached information could be stored. User interface 300 can further include User fields 315 into which desired participants and related schedules 320 can be displayed. As discussed above, user interface 300 can be accessed when the user is online or offline. Whether online or offline, any user information that has been provided by the relationships as described above, conflict resolutions etc., the cache information can be refreshed via control 325. A refresh rate can also be defined via refresh rate control 330. In other exemplary embodiments, other functionality and controls as described above can be further included on user interface 300.

As discussed above, user interface 300 can further include a request field 325 for a chairperson to request calendar information from a participant for which no relationship or information level has been defined. In this way, a chairperson can receive cached information, with the information level detail/granularity being defined by the participant. User interface 300 can further include information detail control 350, which when depressed by a suitable selection device, can launch detail window 355. Detail window 355 can include data fields 360 for the type of indication in which a chairperson is entitled to receive, such as a simple visual indication of available or unavailable, or the detailed account of the participant's calendar. Detail window can further include data fields 365 for the person(s) permitted to cache information for the participant. It is appreciated that once a chairperson has sent a request for calendar information, data field 365 can be updated to include the chairperson if the participant has opted to allow the chairperson to have calendar information. Even with an accepted request, the participant can still choose the level of detail the chairperson is permitted to view via data field 360.

As described above, embodiments can be embodied in the form of computer-implemented processes and apparatuses for practicing those processes. In exemplary embodiments, the invention is embodied in computer program code executed by one or more network elements. Embodiments include computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. Embodiments include computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A computerized method for managing electronic calendar schedules, comprising:
selectively providing calendar information to a chairperson for caching the calendar information related to a group of users while connected to a network;
defining a relationship with the chairperson;
defining an information level depending on the relationship with the chairperson;
periodically updating a log file that contains data related to the information level; and
responding to a proposed meeting schedule.

2. The method as claimed in claim 1 wherein selectively providing calendar information to a chairperson comprises at least one of: denying access to the calendar information; providing a visual indication of calendar information; and providing detailed calendar information.

3. The method as claimed in claim 1 wherein the relationship is defined by at least one of: an instant messenger list; an email list; an enterprise relationship; and a frequent presence on a user's calendar.

4. The method as claimed in claim 3 wherein the information level is defined by at least one of: an instant messenger list; an email list; an enterprise relationship; and a frequent presence on a user's calendar.

5. The method as claimed in claim 1 wherein responding to a proposed meeting schedule is in response to a request from the chairperson who scheduled the proposed meeting while disconnected from the network, the proposed meeting being scheduled based on the cached calendar information.

6. The method as claimed in claim 1 wherein the information level includes an indication of who can receive the calendar information.

7. The method as claimed in claim 1 wherein the information level includes an ability to receive access to scheduled calendar events.

8. In a computer system having a graphical user interface including a display and a selection device, a method for managing electronic calendar schedules, the method comprising:
determining a relationship and an information level with respect to a chairperson;
selectively deciding to allow access to calendar information so that the chairperson can cache the calendar information for online and offline meeting scheduling;
periodically receiving and updating a log file having data related to the information level;
selectively displaying a proposed meeting on the display, the meeting being scheduled based on schedules from cached calendar information of users who gave access to the chairperson; and
informing the chairperson of any conflicts regarding the proposed meeting.

9. The method as claimed in claim 8 wherein the relationship and the information level are determined from at least one of the following: an instant messenger list; an email list; an enterprise relationship; and a frequent presence on a user's calendar.

10. The method as claimed in claim 8 wherein selectively deciding to allow access to calendar information occurs in response to a selection signal indicative of the selection device pointing at a request calendar information field.

11. The method as claimed in claim 8 wherein updating a log file having data related to the information level comprises:
receiving the log file;
determining with whom to share calendar information; and
determining the level of detail of calendar information to share.

12. The method as claimed in claim 11 wherein updating a log file having data related to the information level comprises and least one of revoking access rights to the calendar information and updating access rights, thereby allowing at least one of more and less calendar information detail.

13. The method as claimed in claim 8 further comprising retrieving the level of information from an information detail data field.

14. The method as claimed in claim 13 further comprising launching an information detail window in response to a signal indicative of the selection device pointing at the information detail data field.

15. The method as claimed in claim 14 wherein the information detail window includes a detail field for the level of calendar information to which a chairperson is permitted to view and a data field defining the persons who are permitted to view the calendar information.

16. The method as claimed in claim 8 further comprising displaying a request box on the display so that a participant can provide a selection device signal indicative of selecting the check box, the signal indicating that the participant gives permission to the chairperson to have access to the calendar information

17. A computer readable medium having computer-executable instructions for performing a method, comprising:
managing an electronic calendar coupled to a network;
defining a relationship with a chairperson;
defining an information level to which the chairperson is permitted to access for caching for purposes of scheduling a proposed meeting;
responding to an invitation to a proposed meeting;
informing the chairperson of any conflicts with respect to the proposed meeting;
updating a log file regarding the level of information; and
providing access to calendar information in response to a request for access to the calendar information.

18. The computer readable medium as claimed in claim 17, wherein the method further comprises defining the information level based on at least one of: an instant messenger list; and email list; an enterprise relationship; and a frequent presence on a user's calendar.

19. The computer readable medium as claimed in claim 18, wherein the method further comprises updating the log file by determining with whom to share calendar information and determining the level of detail of calendar information to share.
